(19) United States
(12) Patent Application Publication
(10) Pub. No.: US 2025/0289175 A1
(43) Pub. Date: Sep. 18, 2025

(54) Tool Conveying Device and Heat Shrink Equipment

(71) Applicants: TE Connectivity Solutions GmbH, Schaffhausen (CH); Tyco Electronics (Shanghai) Co., Ltd., Shanghai (CN)

(72) Inventors: Yiqun (Cham) Zhu, Shanghai (CN); Zhen Wang, Shanghai (CN); Moad El Machichi Alami, Meknes (MA)

(73) Assignees: TE Connectivity Solutions GmbH, Schaffhausen (CH); Tyco Electronics (Shanghai) Co., Ltd., Shanghai (CN)

(21) Appl. No.: 19/077,442

(22) Filed: Mar. 12, 2025

(30) Foreign Application Priority Data
Mar. 12, 2024 (CN) 202410282727.7

(51) Int. Cl. B29C 63/48; B29C 61/02; B29C 63/42

(52) U.S. Cl. CPC B29C 63/481; B29C 61/02; B29C 63/42

(57) ABSTRACT

A tool conveying device includes a bracket, a pair of pulleys rotatably mounted on the bracket, an endless belt connected between the pair of pulleys, and holding tools connected to the endless belt and spaced apart from each other. Each of the holding tools includes an extension part and a joint part. The extension part is adapted to be clamped between a pair of conveyor belts of a heat shrink machine, so that the holding tool and the endless belt can circulate along an annular path between a loading position and an unloading position of the heat shrink machine under the drive of the pair of conveyor belts. The joint part is provided on the end of the extension part and is adapted to join with a connection end of heat shrink tube harness product for holding the connection end of the heat shrink tube harness product.

### CROSS-REFERENCE TO RELATED APPLICATION

This application claims the benefit of Chinese Patent Application No. CN202410282727.7 filed on Mar. 12, 2024 in the State Intellectual Property Office of China, the whole disclosure of which is incorporated herein by reference.

### FIELD OF THE DISCLOSURE

The disclosure relates to a tool conveying device and a heat shrink equipment comprising the tool conveying device.

### BACKGROUND OF THE INVENTION

In the prior art, a heat shrink machine used to heat the heat shrink tube harness products typically includes a housing and two pairs of conveyor belts. The heat shrink tubing wire harness product typically includes a wire harness and a heat shrink tube attached to the wire harness, with the wire harness extending from both ends of the heat shrink tube. One end of the heat shrink tube harness product is clamped between one pair of conveyor belts, and the other end is clamped between another pair of conveyor belts. In this way, the heat shrink tube harness products can be transported to the heating chamber of the housing through two pairs of conveyor belts to heat the heat shrink tubing, so that the heat shrink tube is heat shrunk onto the harness.

However, some heat shrink tube harness products have one end crimped with a connecting terminal, which prevents one end of the heat shrink tube harness product from being clamped between one pair of conveyor belts. At this point, an external holding tool is needed to hold and secure one end of the heat shrink tube harness product until it passes through the heating chamber of the heat shrink machine. Finally, the tool will fall into the product recovery box along with the heat shrink tube harness product and mix with the heat shrink tube harness product. The operator needs to frequently move to the back of the heat shrink machine, search for the dropped holding tool, and bring the found holding tool back to the loading position in front of the heat shrink machine, which is very time-consuming and laborious.

### SUMMARY OF THE INVENTION

According to an embodiment of the present disclosure, a tool conveying device includes a bracket, a pair of pulleys rotatably mounted on the bracket, an endless belt connected between the pair of pulleys, and holding tools connected to the endless belt and spaced apart from each other. Each of the holding tools includes an extension part and a joint part. The extension part is adapted to be clamped between a pair of conveyor belts of a heat shrink machine, so that the holding tool and the endless belt can circulate along an annular path between a loading position and an unloading position of the heat shrink machine under the drive of the pair of conveyor belts. The joint part is provided on the end of the extension part and is adapted to join with a connection end of one end of a heat shrink tube harness product for holding the connection end of the heat shrink tube harness product.

### DRAWINGS

The accompanying drawings incorporated therein and forming a part of the specification illustrate the present disclosure and, and together with the description, further serve to explain the principles of the disclosure and to enable those skilled in the relevant art to manufacture and use the embodiments described herein.

FIG. 1 shows an illustrative perspective view of a tool conveying device according to an exemplary embodiment of the present invention;

FIG. 2 shows an illustrative perspective view of a tool conveying device according to an exemplary embodiment of the present invention when viewed from one side, with the housing removed;

FIG. 3 shows an illustrative perspective view of a tool conveying device according to an exemplary embodiment of the present invention when viewed from the other side, with the housing removed;

FIG. 4 shows an illustrative view of a tool conveying device holding a heat shrink tube harness product according to an exemplary embodiment of the present invention;

FIG. 5 shows an illustrative perspective view of a holding tool according to an exemplary embodiment of the present invention;

FIG. 6 shows an illustrative perspective view of a heat shrink machine according to an exemplary embodiment of the present invention;

FIG. 7 shows an illustrative perspective view of a heat shrink machine according to an exemplary embodiment of the present invention, in which the upper housing of the heat shrink machine is removed; and

FIG. 8 shows an illustrative view of a holding tool that is clamped between a pair of conveyor belts of a heat shrink machine for joining the connection end of a heat shrink tube harness product according to an exemplary embodiment of the present invention.

The features disclosed in this disclosure will become more apparent in the following detailed description in conjunction with the accompanying drawings, where similar reference numerals always identify the corresponding components. In the accompanying drawings, similar reference numerals typically represent identical, functionally similar, and/or structurally similar components. Unless otherwise stated, the drawings provided throughout the entire disclosure should not be construed as drawings drawn to scale.

### DETAILED DESCRIPTION

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to an embodiment of the present invention, there is provided a tool conveying device. The tool conveying device comprises of: a bracket; a pair of pulleys which are rotatably mounted on the bracket; an endless belt connected between the pair of pulleys; and multiple holding tools connected to the endless belt and spaced apart from each other. The holding tool comprises: an extension part which is suitable for being clamped between a pair of conveyor belts of a heat shrink machine, so that the holding tool and the endless belt can circulate along an annular path between a loading position and an unloading position of the heat shrink machine under the drive of the pair of conveyor belts; and a joint part which is provided on the end of the extension part and is suitable for joining with a connection end of one end of a heat shrink tube harness product, used to hold the connection end of the heat shrink tube harness product.

According to another embodiment of the present invention, there is provided a heat shrink equipment. The heat shrink equipment comprises of: a heat shrink machine comprising a housing and two pairs of conveyor belts for transporting heat shrink tube harness products into a heating chamber inside the housing; and the above tool conveying device installed on one side of the housing of the heat shrink machine. The heat shrink tube harness product has a connection end located at one end and a wire harness end located at the other end, the extension part of the holding tool that is joined to the connection end of the heat shrink tube harness product is clamped between one pair of conveyor belts of the heat shrink machine, and the wire harness end of the heat shrink tube harness product is clamped between the other pair of conveyor belts of the heat shrink machine.

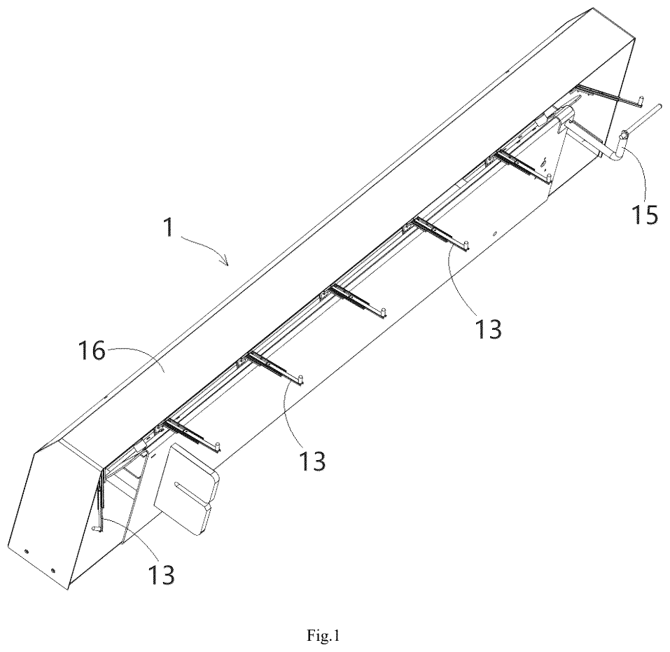

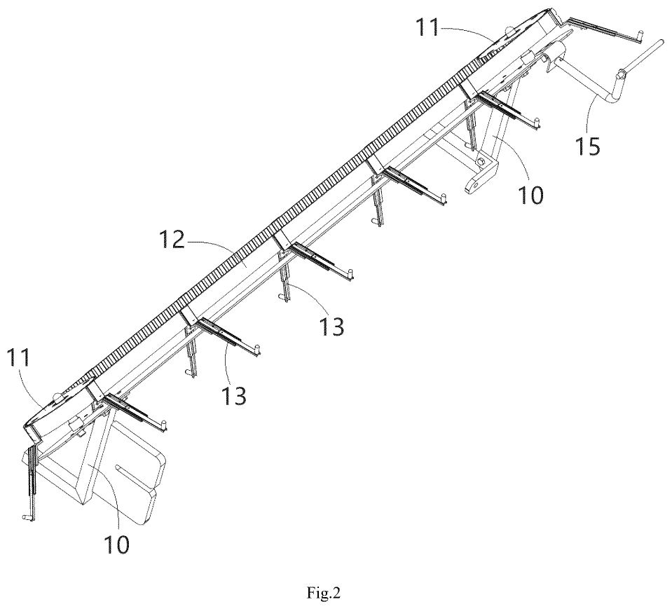

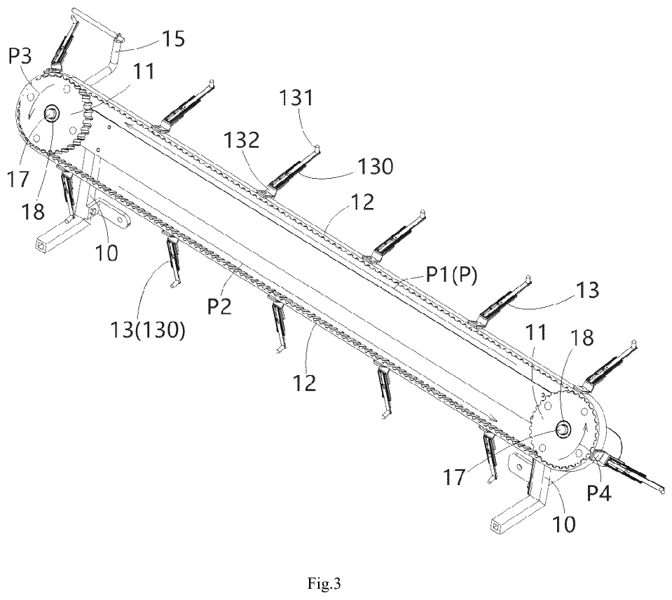

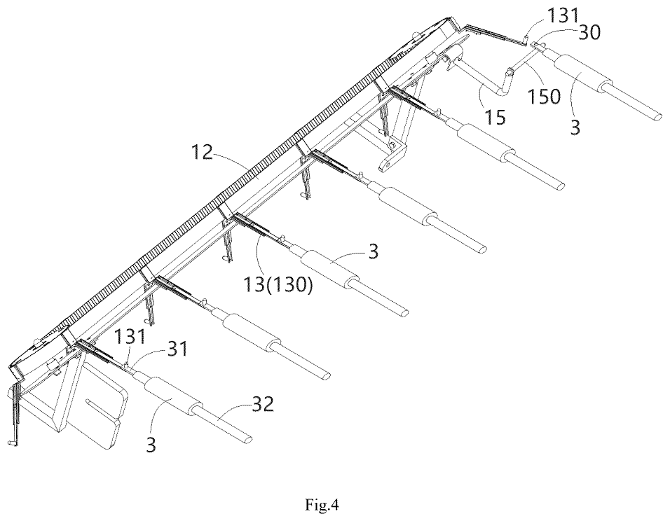

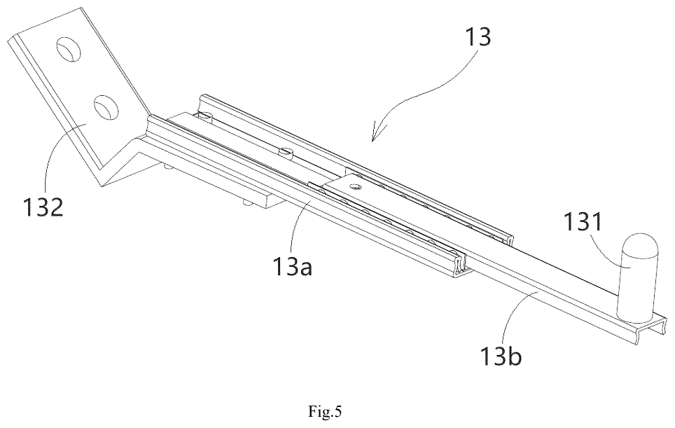

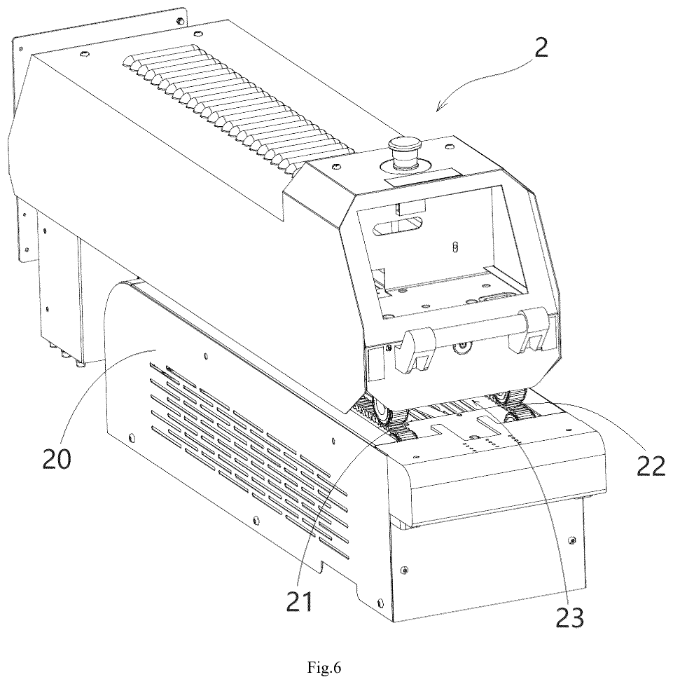

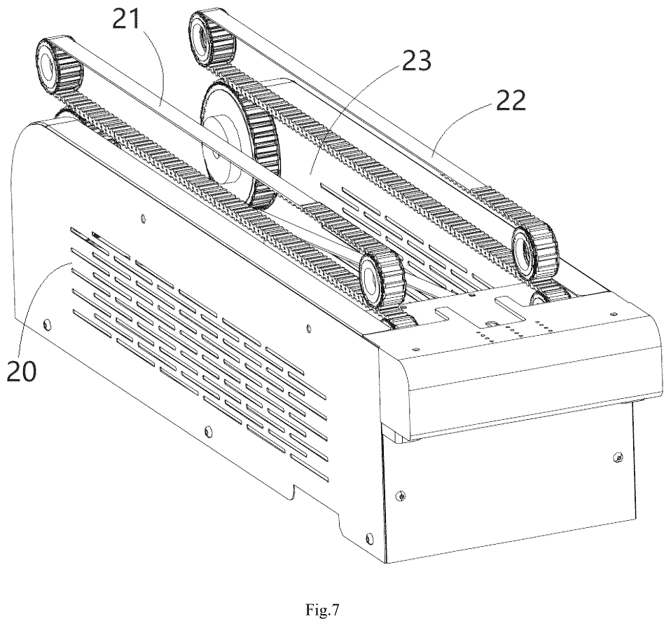

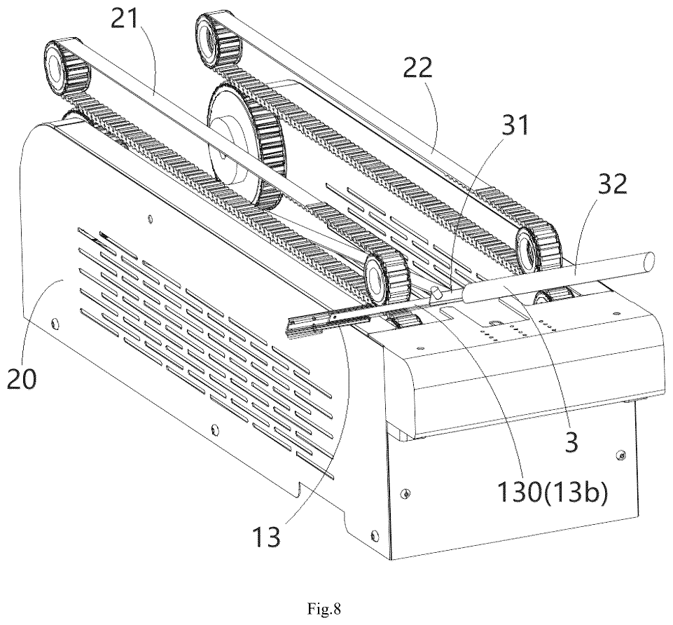

FIG. 1 shows an illustrative perspective view of a tool conveying device 1 according to an exemplary embodiment of the present invention; FIG. 2 shows an illustrative perspective view of the tool conveying device 1 according to an exemplary embodiment of the present invention when viewed from one side, with the housing 16 removed; FIG. 3 shows an illustrative perspective view of the tool conveying device 1 according to an exemplary embodiment of the present invention when viewed from the other side, with the housing 16 removed; FIG. 4 shows an illustrative view of a tool conveying device 1 holding a heat shrink tube harness product 3 according to an exemplary embodiment of the present invention; FIG. 5 shows an illustrative perspective view of a holding tool 13 according to an exemplary embodiment of the present invention; FIG. 6 shows an illustrative perspective view of a heat shrink machine 2 according to an exemplary embodiment of the present invention; FIG. 7 shows an illustrative perspective view of a heat shrink machine 2 according to an exemplary embodiment of the present invention, in which the upper housing of the heat shrink machine 2 is removed; FIG. 8 shows an illustrative view of the holding tool 13 clamped between a pair of conveyor belts 21 of the heat shrink machine 2, which is connected to the connection end 31 of the heat shrink tube harness product 3 according to an exemplary embodiment of the present invention.

As shown in FIGS. 1 to 8, in an exemplary embodiment of the present invention, a tool conveying device 1 is disclosed. The tool conveying device 1 includes a bracket 10, a pair of pulleys 11, an endless belt 12, and multiple holding tools 13. The pair of pulleys 11 are rotatably mounted on the bracket 10. The endless belt 12 is connected between the pair of pulleys 11. Multiple holding tools 13 are connected to the endless belt 12 and spaced apart from each other.

The holding tool 13 includes an extension part 130 and a joint part 131. The extension part 130 of the holding tool 13 is suitable for being clamped between a pair of conveyor belts 21 of the heat shrink machine 2, so that the holding tool 13 and the endless belt 12 can circulate along the annular path P between the loading position and the unloading position of the heat shrink machine 2 under the drive of the pair of conveyor belts 21. The joint part 131 of the holding tool 13 is set at the end of the extension part 130 and is suitable for joining with the connection end 31 (e.g. crimping terminal) of the heat shrink tube harness product 3, used to hold the connection end 31 of the heat shrink tube harness product 3.

The annular path Pincludes a first straight linear path P1, and the holding tool 13 is adapted to move along the first straight linear path PI from the loading position of the heat shrink machine 2 to the unloading position of the heat shrink machine 2 under the drive of a pair of conveyor belts 21 of the heat shrink machine 2. When the holding tool 13 is moved to the first straight linear path P1, the extension part 130 of the holding tool 13 is in a horizontal orientation parallel to the horizontal direction (to be parallel to the transverse direction of the heat shrink machine 2), so that the extension part 130 can be clamped between a pair of conveyor belts 21 of the heat shrink machine 2.

In the illustrated embodiment, the aforementioned annular path P further includes a second straight linear path P2, a first semi-circular path P3, and a second semi-circular path P4. The second straight linear path P2 is parallel and opposite to the first straight linear path P1. The first semi-circular path P3 is located between one ends of the first straight linear path Pl and the second straight linear path P2. The second semi-circular path P4 is located between the other ends of the first straight linear path P1 and the second straight linear path P2. The holding tool 13 is adapted to be moved along the first semi-circular path P3, the second straight linear path P2, and the second semi-circular path P4 from the discharge position of heat shrink machine 2 to the loading position of heat shrink machine 2 under the drive of a pair of conveyor belts 21 of heat shrink machine 2. In this way, the holding tool 13 can be automatically returned to the loading position, saving time and effort.

The rotation axis of the pulley 11 is inclined at a predetermined angle relative to the horizontal plane, and the angle between the extension direction of the extension part 130 of the holding tool 13 and the rotation axis of the pulley 11 is equal to the predetermined angle.

The predetermined angle is greater than 30 degrees and less than 60 degrees, so that when the holding tool 13 is moved to the second straight linear path P2, the angle between the extension direction of the extension part 130 of the holding tool 13 and the vertical direction is not greater than 30 degrees. In this way, it can prevent the extension part 130 of the holding tool 13 from interfering with the housing 20 of the heat shrink machine 2 when it moves along the second straight linear path P2. The predetermined angle is equal to 45 degrees, so that when the holding tool 13 is moved to the second straight linear path P2, the extension part 130 of the holding tool 13 is in a vertical orientation parallel to the vertical direction.

The holding tool 13 further includes an installation block 132, which is connected to the endless belt 12, and one end of the extension part 130 is connected to the installation block 132. The installation block 132 is detachably connected to the endless belt 12, allowing the holding tool 13 to be quickly replaced. For example, the installation block 132 can be fastened to the endless belt 12 by bolts. The extension part 130 includes a fixed rod 13a and a movable rod 13b. One end of the fixed rod 13a is connected to the installation block 132. The movable rod 13b is connected to the fixed rod 13a in a movable manner. The movable rod 13b can be moved relative to the fixed rod 13a along the extension direction of the extension part 130, so that the extension length of the extension part 130 can be adjusted, and the movable rod 13b is suitable for being clamped between a pair of conveyor belts 21 of the heat shrink machine 2. The joint part 131 includes a joint pin fixed to the end of the extension part 130, which is adapted to be inserted and engaged into the connection hole 30 in the connection end 31 of the heat shrink tube harness product 3 to hold the connection end 31 of the heat shrink tube harness product 3.

The tool conveying device 1 further includes a pair of support shafts 17 and a pair of bearings 18. The pair of support shafts 17 are fixed on the bracket 10. The pair of bearings 18 are respectively installed on the pair of support shafts 17. The pair of pulleys 11 are respectively installed on the pair of bearings 18, so that the pulleys 11 can be freely rotated around the axis of the support shaft 17.

The tool conveying device 1 further comprises a housing 16. The bracket 10, the pulley 11 and the endless belt 12 are accommodated in the housing 16. The inner side of housing 16 is fixed to the bracket 10, and a slot is formed on the housing 16 to allow the holding tool 13 to extend out.

The tool conveying device 1 further comprises an unloading tool 15, which is fixed to the bracket 10 for separating the heat shrink tube harness product 3 from the holding tool 13 after the heat shrink tube harness product 3 passes through the heating chamber 23 of the heat shrink machine 2.

The unloading tool 15 includes a blocking rod 150, which is perpendicular to the axial direction of the heat shrink tube harness product 3 passing through the heating chamber 23 of the heat shrink machine 2, to block the heat shrink tube harness product 3 at the predetermined unloading position and detach it from the holding tool 13.

As shown in FIGS. 1 to 8, in another exemplary embodiment of the present invention, a heat shrink equipment is also disclosed. The heat shrink equipment includes a heat shrink machine 2 and the aforementioned tool conveying device 1. The heat shrink machine 2 includes a housing 20 and two pairs of conveyor belts 21, 22 used to transport the heat shrink tube harness products 3 into the heating chamber 23 inside the housing 20. The tool conveying device 1 is installed on one side of the housing 20 of the heat shrink machine 2. The heat shrink tube harness product 3 has a connection end 31 located at one end and a harness end 32 located at the other end. The extension part 130 of the holding tool 13, which is connected to the connection end 31 of heat shrink tube harness product 3, is clamped between a pair of conveyor belts 21 of heat shrink machine 2, and the wire harness end 32 of heat shrink tube harness product 3 is clamped between another pair of conveyor belts 22 of heat shrink machine 2.

The housing 20 of the heat shrink machine 2 has two opposite sides in its transverse direction, and the tool conveying device 1 is fixed to one side of the housing 20 of the heat shrink machine 2. The heating chamber 23 of the heat shrink machine 2 has an inlet and outlet that are opposite in the longitudinal direction of the housing 20 of the heat shrink machine 2, and the unloading tool 15 of the tool conveying device 1 is located at the outlet of the heating chamber 23. The transverse and longitudinal directions of the housing 20 of the heat shrink machine 2 define a horizontal plane, and the rotation axis of the pulley 11 of the tool conveying device 1 is inclined at a predetermined angle relative to the horizontal plane.

When the holding tool 13 moves along the first straight linear path PI between the inlet and outlet of the heating chamber 23 of the heat shrink machine 2, the extension direction of the extension part 130 of the holding tool 13 is parallel to the transverse direction of the housing 20 of the heat shrink machine 2, so that the extension part 130 can be clamped between a pair of conveyor belts 21 of the heat shrink machine 2.

The heat shrink machine 2 also includes a product recovery box (not shown) located below the outlet of the heating chamber 23. After passing through the heating chamber 23, the heat shrink tube harness product 3 is separated from the holding tool 13 under the obstruction of the unloading tool 15 and fell into the product recovery box. The holding tool 13 is returned to the loading position of heat shrink machine 2 along with the endless belt 12 from the unloading position of heat shrink machine 2.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A tool conveying device, comprising:
a bracket;
a pair of pulleys which are rotatably mounted on the bracket;
an endless belt connected between the pair of pulleys; and
holding tools connected to the endless belt and spaced apart from each other, each of the holding tools including:
an extension part which is suitable for being clamped between a pair of conveyor belts of a heat shrink machine, so that the holding tool and the endless belt can circulate along an annular path between a loading position and an unloading position of the heat shrink machine under the drive of the pair of conveyor belts; and
a joint part which is provided on the end of the extension part and is suitable for joining with a connection end of one end of a heat shrink tube harness product, used to hold the connection end of the heat shrink tube harness product.

2. The tool conveying device according to claim 1, wherein:
the annular path comprises a first straight linear path, and the holding tool is adapted to be moved along the first straight linear path from the loading position of the heat shrink machine to the unloading position of the heat shrink machine under the drive of the pair of conveyor belts of the heat shrink machine; and
when the holding tool is moved to the first straight linear path, the extension part of the holding tool is in a horizontal orientation parallel to the horizontal direction, so that the extension part can be clamped between the pair of conveyor belts of the heat shrink machine.

3. The tool conveying device according to claim 2, wherein the annular path further includes:
a second straight linear path which is parallel and opposite to the first straight linear path;
a first semi-circular path which is located between one ends of the first straight linear path and the second straight linear path; and
a second semi-circular path which is located between the other ends of the first straight linear path and the second straight linear path,
wherein the holding tool is adapted to be moved along the first semi-circular path, the second straight linear path, and the second semi-circular path from the discharge position of the heat shrink machine to the loading position of the heat shrink machine under the drive of the pair of conveyor belts of the heat shrink machine.

4. The tool conveying device according to claim 3, wherein the rotation axis of the pulley is inclined at a predetermined angle relative to the horizontal plane, and the angle between the extension direction of the extension part of the holding tool and the rotation axis of the pulley is equal to the predetermined angle.

5. The tool conveying device according to claim 4, wherein the predetermined angle is greater than 30 degrees and less than 60 degrees, so that when the holding tool is moved to the second straight linear path, the angle between the extension direction of the extension part of the holding tool and the vertical direction is not greater than 30 degrees.

6. The tool conveying device according to claim 4, wherein the predetermined angle is equal to 45 degrees, so that when the holding tool is moved to the second straight linear path, the extension part of the holding tool is in a vertical orientation parallel to the vertical direction.

7. The tool conveying device according to claim 1, wherein the holding tool further comprises an installation block, which is connected to the endless belt, and one end of the extension part is connected to the installation block.

8. The tool conveying device according to claim 7, wherein the installation block is detachably connected to the endless belt.

9. The tool conveying device according to claim 7, wherein the extension part comprises:
a fixed rod, one end of which is connected to the installation block; and
a movable rod connected to the fixed rod in a movable manner.

10. The tool conveying device according to claim 9, wherein the movable rod can be moved relative to the fixed rod along the extension direction of the extension part, so that the extension length of the extension part can be adjusted, and the movable rod is suitable for being clamped between the pair of conveyor belts of the heat shrink machine.

11. The tool conveying device according to claim 7, wherein the joint part comprises a joint pin fixed to the end of the extension part, which is adapted to be inserted and engaged into a connection hole in the connection end of the heat shrink tube harness product to hold the connection end of the heat shrink tube harness product.

12. The tool conveying device according to claim 1, further comprising:
a pair of support shafts fixed on the bracket; and
a pair of bearings which are respectively installed on the pair of support shafts, wherein the pair of pulleys are respectively installed on the pair of bearings, so that the pulleys can freely rotate around the axis of the support shaft.

13. The tool conveying device according to claim 1, further comprising a housing in which the bracket, the pulley and the endless belt are received, wherein the inner side of the housing is fixed to the bracket, and a slot is formed on the housing to allow the holding tool to extend out.

14. The tool conveying device according to claim 1, further comprising an unloading tool which is fixed to the bracket and is used to detach the heat shrink tube harness product from the holding tool after the heat shrink tube harness product passes through a heating chamber of the heat shrink machine.

15. The tool conveying device according to claim 13, wherein the unloading tool comprises a blocking rod, which is perpendicular to the axial direction of the heat shrink tube harness product passing through the heating chamber of the heat shrink machine, to block the heat shrink tube harness product at a predetermined unloading position and detach it from the holding tool.

16. A heat shrink equipment, comprising:
a heat shrink machine comprising a housing and two pairs of conveyor belts for transporting heat shrink tube harness products into a heating chamber inside the housing; and a tool conveying device installed on one side of the housing of the heat shrink machine, the tool conveying device including:
a bracket;
a pair of pulleys which are rotatably mounted on the bracket;
an endless belt connected between the pair of pulleys; and
holding tools connected to the endless belt and spaced apart from each other, each of the holding tools including:
an extension part which is suitable for being clamped between a pair of conveyor belts of a heat shrink machine, so that the holding tool and the endless belt can circulate along an annular path between a loading position and an unloading position of the heat shrink machine under the drive of the pair of conveyor belts; and
a joint part which is provided on the end of the extension part and is suitable for joining with a connection end of one end of a heat shrink tube harness product, used to hold the connection end of the heat shrink tube harness product, wherein the heat shrink tube harness product has a connection end located at one end and a wire harness end located at the other end, the extension part of the holding tool that is joined to the connection end of the heat shrink tube harness product is clamped between one pair of conveyor belts of the heat shrink machine, and the wire harness end of the heat shrink tube harness product is clamped between the other pair of conveyor belts of the heat shrink machine.

17. The heat shrink equipment according to claim 16, wherein:
the housing of the heat shrink machine has two opposite sides in its transverse direction, and the tool conveying device is fixed to one side of the housing of the heat shrink machine; and
the heating chamber of the heat shrink machine has an inlet and an outlet that are opposite in the longitudinal direction of the housing of the heat shrink machine, and the unloading tool of the tool conveying device is located at the outlet of the heating chamber.

18. The heat shrink equipment according to claim 17, wherein the transverse direction and the longitudinal direction of the housing of the heat shrink machine define a horizontal plane, and the rotation axis of the pulley of the tool conveying device is inclined at a predetermined angle relative to the horizontal plane.

19. The heat shrink equipment according to claim 17, wherein when the holding tool is moved between the inlet and outlet of the heating chamber of the heat shrink machine, the extension direction of the extension part of the holding tool is parallel to the transverse direction of the housing of the heat shrink machine, so that the extension part can be clamped between one pair of conveyor belts of the heat shrink machine.

20. The heat shrink equipment according to claim 16, wherein:
the heat shrink machine further comprises a product recovery box, which is located below the outlet of the heating chamber; and
the heat shrink tube harness product is separated from the holding tool and dropped into the product recovery box under the obstruction of the unloading tool after passing through the heating chamber.
